(19) United States
(12) Patent Application Publication
(10) Pub. No.: US 2020/0233156 A1
(43) Pub. Date: Jul. 23, 2020

(54) DUAL END OPTICAL CLEANING DEVICE

(71) Applicant: Fluke Corporation, Everett, WA (US)

(72) Inventors: J. David Schell, Austin, TX (US); Wayne S. Hoofnagle, Kirkland, WA (US); Roger L. Howell, Seattle, WA (US)

(21) Appl. No.: 16/252,403

(22) Filed: Jan. 18, 2019

(51) Int. Cl. G02B 6/38; B08B 1/00; B08B 11/00

(52) U.S. Cl. CPC G02B 6/3866; B08B 1/00; B08B 2240/02; B08B 11/00; G02B 6/3897

(57) ABSTRACT

Embodiments are directed to a dual end optical cleaning device. The dual end optical cleaning device includes a housing and first and second optical cleaning tools that are held in opposing directions in the housing. That is, the housing holds the first and second optical cleaning tools such that ends of the first and second optical cleaning tools are facing opposite directions of each other. The ends of the first and second optical cleaning tools are configured to clean optical fibers being held by different end pieces. In at least one embodiment, an end of the first optical cleaning tool is configured to couple to a connector holding an optical fiber, such as patch cord, while the second end of the second optical cleaning tool is configured to be inserted into a port of an electronic device or system, such as a patch panel port.

### BACKGROUND

### Technical Field

The present disclosure generally pertains to cleaning of optical fibers, such as optical fiber cables.

### Description of the Related Art

Optical fibers enable high speed transmission of data with relatively low loss. In view of this, optical fibers are often used in telecommunication networks, such as telephone lines, cable systems and the internet. Patch cords may be used to make adjustments to a network, such as adding, dropping, or moving optical cables in the network, or for coupling and decoupling to various transmitting and receiving equipment. Patch cords include one or more ends of an optical fiber that is held by a connector, such as a ceramic ferrule. The connectors are designed to align the endfaces of the optical fibers of two fiber optic cables to be coupled, and to abut the endfaces of the optical fibers of the fiber optic cables in physical contact with each other.

Performance of optical fibers is affected by the quality of the connection between abutting optical fibers. One element known to affect the quality of the connection is the cleanliness of the endfaces of the optical fibers. For instance, defects between optical fibers of two abutting fiber optic cables may block, diffuse, or misdirect the optical signal traveling from one optical fiber to another abutting optical fiber, thereby affecting the quality of the signal, such as reducing the intensity of the signal or introducing artifacts into the signal. Furthermore, defects may cause damage to endfaces of optical fibers of another fiber optic cable upon coupling of the two fiber optic cables. Defects may include any contamination, artifacts, flaws in the optical fibers, or anything else that may affect an optical signal. Thus, the integrity of the endfaces of optical fibers in a fiber optic cable is of significant importance.

To eliminate or at least reduce problems associated with endface contamination, the endfaces of the fiber optic cables may be cleaned prior to being coupled together. Optical cleaning tools are often used to clean the endfaces of the optical fiber. In some cases, many endfaces of optical fibers are cleaned at patch panels, which involves coupling a plurality of patch cords to patch panel ports. Endfaces for patch cords have a different configuration and shape from patch panels ports. Thus, different optical cleaning tools are used to clean patch cords than are used to clean patch panel ports.

More recently, an adapter, which is basically a connector, is coupled to an end of the optical cleaning tool in a way that allows the optical cleaning tool to be used to clean optical fibers of both patch cords and patch panel ports. Although the adapter allows for a single optical cleaning tool to be used, the user must install and remove the adapter in order to change the configuration of the optical cleaning tool when cleaning optical fibers for both patch cords and patch panel ports.

When a technician is coupling patch cords to patch panel ports, the technician must quickly couple the patch cord to the patch panel port after the endfaces of the optical fibers of each have been cleaned in order to ensure the integrity of the coupling therebetween. Thus, after cleaning an endface of an optical fiber of a patch cord, the technician will have to remove the adapter, so that the optical cleaning tool is in a configuration to clean an endface of an optical fiber of the corresponding patch panel port. When a patch panel has hundreds of patch panel ports, this process can be slow and tedious. Thus, there is a need for an improved optical cleaning tool.

### BRIEF SUMMARY

Embodiments are directed to a dual end optical cleaning device. The dual end optical cleaning device includes a housing and first and second optical cleaning tools that are held in opposing directions in the housing. That is, the housing holds the first and second optical cleaning tools such that ends of the first and second optical cleaning tools are facing opposite directions of each other. The ends of the first and second optical cleaning tools are configured to clean optical fibers being held by different end pieces. In at least one embodiment, an end of the first optical cleaning tool is configured to couple to a connector holding an optical fiber, such as patch cord, while the second end of the second optical cleaning tool is configured to be inserted into a port of an electronic device or system, such as a patch panel port.

One embodiment is directed to a dual end optical cleaning device comprising a housing including a first receiving section and a second receiving section. A first optical cleaning tool is located in the first receiving section such that an end of the first optical cleaning tool is facing a first direction. A a second optical cleaning tool is located in the second receiving section such that an end of the second optical cleaning tool is facing a second direction. The second direction is opposite the first direction.

Another embodiment is directed to a dual end optical cleaning device comprising a first portion holding a first optical cleaning tool so that an end of the first optical cleaning tool is facing in a first direction. The dual end optical cleaning device further includes a second portion holding a second optical cleaning tool so that an end of the second optical cleaning tool is facing a second, different direction. The first portion and the second portion are coupled together at a coupling region. In some embodiments, the coupling region, the first portion, and the second portion are a single integral piece.

Another embodiment is directed to a method comprising coupling a first end of a dual end optical cleaning device to an endface of an optical fiber that is held by a connector. The first end has a first cleaning element and extends in a first direction. The method further includes cleaning the endface of the optical fiber that is held by the connector using the first cleaning element. The method further includes rotating the dual end optical cleaning device and coupling a second end of the dual end optical cleaning device to an endface of an optical fiber that is held in a port. The second end has a second cleaning element and extending in a second, opposite direction. The method further includes cleaning the endface of the optical fiber that is held in the port using the second cleaning element.

### BRIEF DESCRIPTION OF THE SEVERAL VIEWS OF THE DRAWINGS

In the drawings, identical reference numbers identify similar elements. The sizes and relative positions of elements in the drawings are not necessarily drawn to scale.

FIGS. 1A-1E illustrate a dual end optical cleaning device in accordance with an embodiment of the present disclosure.

FIGS. 2A and 2B illustrate the dual end optical cleaning device of FIGS. 1A-1E coupled to a connector and a port, respectively.

FIGS. 3A-3B illustrate the housing of the dual end optical cleaning device in FIGS. 1A-1E.

FIGS. 4A-4D illustrate a dual end optical cleaning device in accordance with another embodiment of the present disclosure.

FIGS. 5A-5B illustrate the housing of the dual end optical cleaning device in FIGS. 4A-4D.

### DETAILED DESCRIPTION

It will be appreciated that, although specific embodiments of the present disclosure are described herein for purposes of illustration, various modifications may be made without departing from the spirit and scope of the present disclosure. Described herein are various embodiments of a dual end optical cleaning device. The dual end optical cleaning device includes a housing and first and second optical cleaning tools that are held in opposing directions in the housing. That is, the housing holds the first and second optical cleaning tools such that ends of the first and second optical cleaning tools are facing opposite directions of each other. The ends of the first and second optical cleaning tools are configured to clean optical fibers being held by different end pieces. In at least one embodiment, an end of the first optical cleaning tool is configured to couple to a connector holding an optical fiber, such as a patch cord, while the second end of the second optical cleaning tool is configured to be inserted into a port of an electronic device or system, such as a patch panel port.

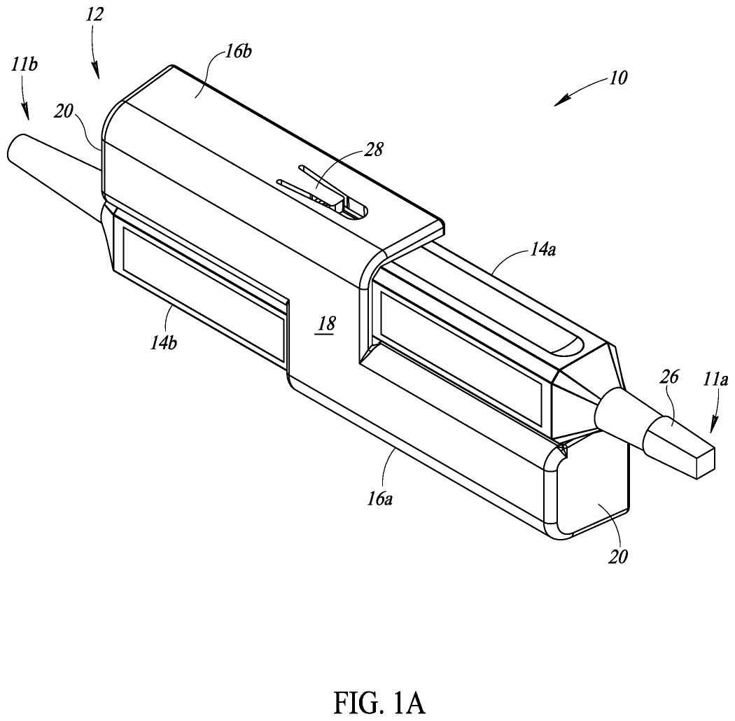

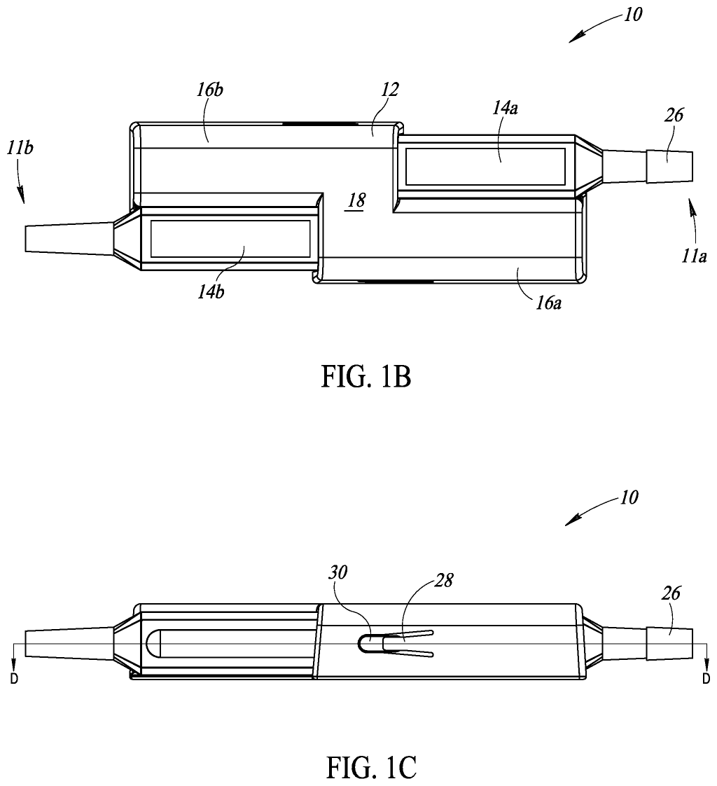

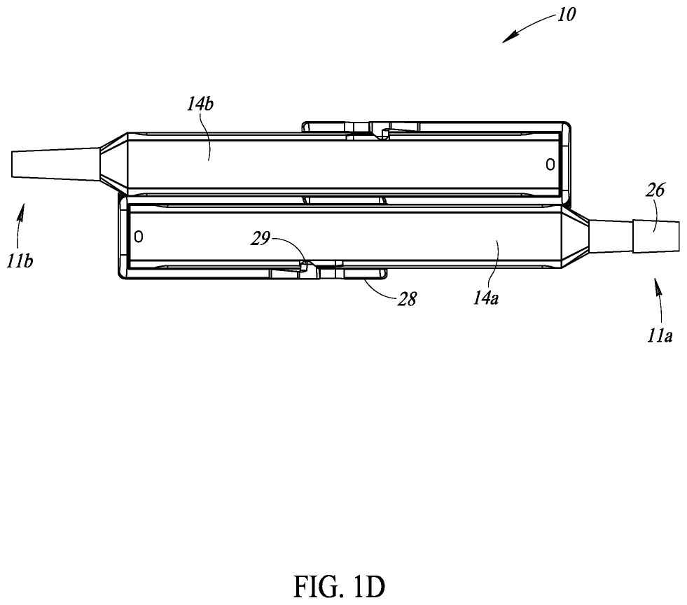

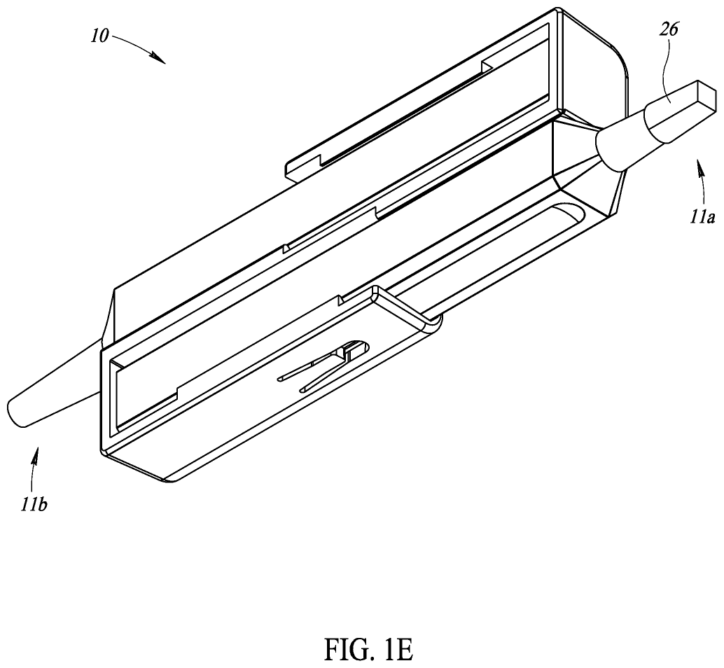

FIGS. 1A-1E show a dual end optical cleaning device 10 in accordance with at least one embodiment. In particular, FIG. 1A is a top isometric view of the dual end optical cleaning device 10; FIG. 1B is a top plan view of the dual end optical cleaning device 10; FIG. 1C is a side view of the dual end optical cleaning device 10; FIG. 1D is a cross section view of FIG. 1C without showing the internal details of the optical cleaning tools; and FIG. 1E is a bottom isometric view of the dual end optical cleaning device 10.

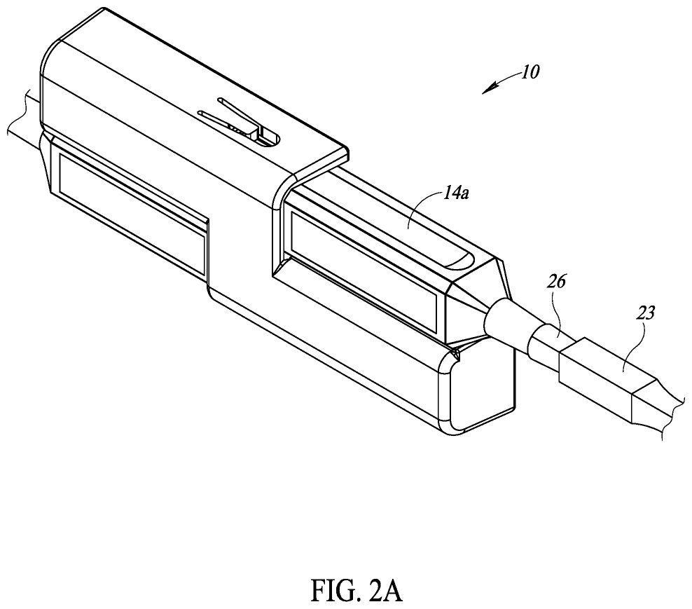

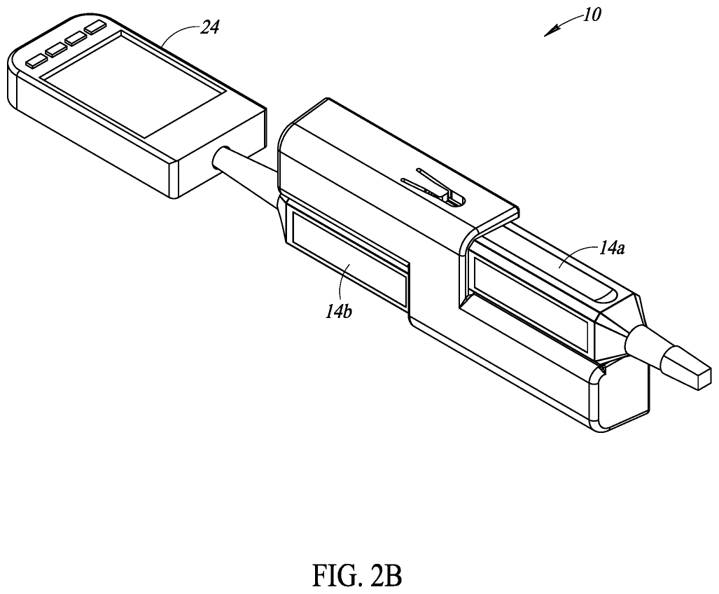

The dual end optical cleaning device 10 has a first end 11a and a second end 11b. The dual end optical cleaning device 10 includes a housing 12 that holds first and second optical cleaning tools 14a, 14b in opposite directions at the first and second ends 11a, 11b. The first and second optical cleaning tools 14a, 14b are identical to each other except that the first and second optical cleaning tools 14a, 14b are configured to clean endfaces of optical fibers being held in different configurations. That is, at the first end 11a, the first optical cleaning tool 14a has an end configured to clean optical fibers held in a first configuration, while at the second end 11b, the second optical cleaning tool 14b has an end configured to clean optical fibers held in a second, different configuration. For instance, the first optical cleaning tool 14a is configured to clean an endface of an optical fiber held by a connector 23 (FIG. 2A), such as a connector of a patch cord, while the second optical cleaning tool 14b is configured to clean an endface of an optical fiber of a port, such as an electronic device 24 (FIG. 2B) or a patch panel port. Thus, in use, the first optical cleaning tool 14a is used clean an endface of an optical fiber, such as a patch cord; then the dual end optical cleaning device 10 is rotated 180° so that the second optical cleaning tool 14b is used to clean a port, such as a patch panel port, or vice versa.

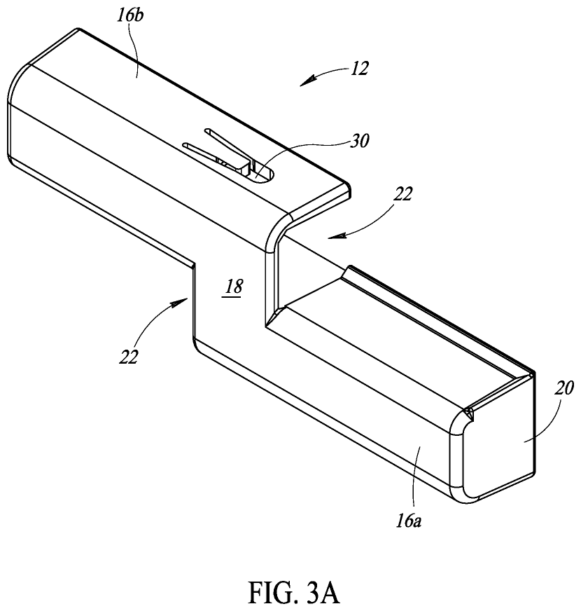

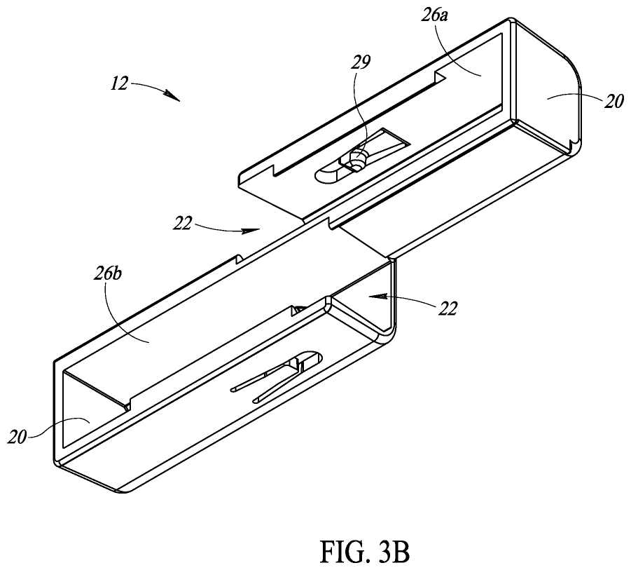

FIGS. 3A-3D illustrate the housing 12 without the first and second optical cleaning tools 14a, 14b installed therein. The housing 12 includes a first portion 16a coupled to a second portion 16b at a coupling region 18. The first and second portions 16a, 16b have closed ends 20 and open ends 22 facing in opposite directions from each other. The first and second portions 16a, 16b are coupled together proximate the open ends 22 at the coupling region 18. In particular, side surfaces of the first and second portions 16a, 16b are coupled together proximate the open ends 22. In at least one embodiment, the first and second portions 16a, 16b of the housing 12 are integrally formed with each other at the coupling region to form a single integral housing.

The first portion 16a includes a first receiving section 26a that is configured to receive and hold a first optical cleaning tool 14a, while the second portion 16b includes a second receiving section 26b that is configured to receive and hold a second optical cleaning tool 14b. As previously mentioned, the first and second cleaning tools 14a, 14b are held in the housing 12 in opposing directions from each other.

As best shown in FIGS. 1D, 1E, and 3B, a bottom of the first and second portions 16a, 16b may be open. In other embodiments, however, the first and second portions 16a, 16b cover all sides of the first and second optical cleaning tools 14a, 14b that are located therein. The shape of the first and second portions 16a, 16b correspond to the shape of the first and second optical cleaning tools 14a, 14b. Thus, although the shape of the first and second portions 16a, 16b are generally of a rectangular shape, the shape of the first and second portions may be a different geometry depending on the shape of the first and second optical cleaning tools.

As previously mentioned, the first optical cleaning tool 14a has an end configured to clean optical fibers in a first configuration, while the second optical cleaning tool 14b has an end configured to clean optical fibers in a second configuration. In one embodiment, the first and second cleaning tools 14a, 14b are identical to each other, however, the end of the first optical cleaning tool 14a has an adapter 25 installed thereon and is configured to clean an endface of an optical fiber of a patch cord, while the end of the second optical cleaning tool 14b is configured to clean an endface of an optical fiber of a patch panel port. The adapter 25 is a connector, such as a ceramic ferrule, that is connected at the end of the first optical cleaning tool 14a.

With reference to FIG. 2A, the adapter 25 at the end of the first optical cleaning tool 14a is configured to couple to a connector 23 holding an endface of an optical fiber cable to be cleaned, such as a patch cord. In particular, the adapter 25 places a cleaning element of the first optical cleaning tool 14a in abutting relationship with the endface of the optical fiber cable to be cleaned. In at least one embodiment, the adapter 25 of the first optical cleaning tool in the first configuration has a square tip that is configured to clean 1.25 mm ferrules. With reference to FIG. 2B, the end of the second optical cleaning tool 14b is configured to couple with a port of an electronic device 24 or system that includes an optical fiber, such as a patch panel port. The port of the electronic device 24 includes an internal connector such that when the end of second optical connector 14b is inserted into the port, the cleaning element is placed in abutting relationship with the endface of the optical fiber within the electronic device or the patch panel port. In at least one embodiment, the end of the second optical cleaning tool 14b in the second configuration has a cylindrical tip that is configured to clean 2.5 mm ferrules.

The first and second portions 16a, 16b include latching members 28 or resilient members that aid in holding the first and second optical cleaning tools 14a, 14b in the first and second receiving sections 26a, 26b. The first and second portions 16a, 16b include latching members 28 that are positioned and configured to mate with a receiving member, such as a groove, indent, or opening, of the first and second optical cleaning tools 14a, 14b. In at least one embodiment, the latching member 28 includes a flexible portion and a protrusion 29. The flexible portion is configured to flex when the optical cleaning tool is being installed into and removed from the respective receiving section, while the protrusion 29 is configured to engage with the receiving member of the optical cleaning tool. The latching members 28 may be formed integrally with the first and second portions 16a, 16b or may be coupled to the first and second portions 16a, 16b.

A user may replace one of the optical cleaning tools 14a, 14b by pulling the optical cleaning tool 14a, 14b from the respective receiving section 26a, 26b. As the optical cleaning tool 14a, 14b is pulled from the receiving section 26a, 26b, the flexible portion of the latching member 28 flexes away from the optical cleaning tool 14a, 14b causing the protrusion to disengage with the receiving member of the optical cleaning tool 14a, 14b, which allows the cleaning to be fully removed from the receiving section 26a, 26b. Similarly, as an optical cleaning tool 14a, 14b is pushed into the receiving section 26a, 26b, the flexible portion of the latching member 28 pushes the protrusion away from the optical cleaning tool 14a, 14b to allow the optical cleaning tool 14a, 14b to be received in the receiving section 26a, 26b. Once the optical cleaning tool is fully received into the receiving section 26a, 26b, the protrusion 29 engages with the receiving member of the optical cleaning tool 14a, 14b to hold the optical cleaning tool in the receiving section 26a, 26b.

In at least one embodiment, the housing 12 is formed from an integral rigid plastic material that has suitable flexibility to form the latching member 28. In particular, the flexible portion of the latching member 28 is connected at one end to the housing 12, while the other end is free to flex. In at least one embodiment, the housing 12 is made from three-dimensional (3D) printed plastic. In another embodiment, the housing 12 is a single piece of plastic material formed by injection molding.

The cleaning elements of the first and second optical cleaning tools 14a, 14b may be any suitable material, such as tape or cleaning cloths. In some embodiments, tape is exposed at the end of the tool and configured to be moved along the end. The tape is held by a supply reel that provides the tape to the end and a winding reel that holds the tape after it has been used to clean an endface of an optical fiber. The ends of the optical cleaning tools 14a, 14b may be configured to rotate within while the cleaning element cleans the endface of the optical fiber.

The first and second portions 16a, 16b of the housing 12 include openings 30 that allow a user to see the tape on at least one of the supply reel or the winding reel of the optical cleaning tools while the optical cleaning tools are inside the housing. Thus, the user can use this information to determine when to remove and replace the optical cleaning tool as discussed above.

Advantageously, the dual end optical cleaning device 10 allows for a user to use a single tool without having to remove and replace an adapter to clean optical fibers having different connectors at their ends, such as is the case for patch cords and patch panel ports. A user may use a first end 11a of the optical cleaning device 10 to clean an endface of an optical fiber being held by a connector 23 as shown in FIG. 2A and then rotate or flip the dual end optical cleaning device 10, such as 180°, to use the second end 11a of the dual end optical cleaning device 10 to clean an endface of an optical fiber in a port of an electronic device 24, as shown in FIG. 2B or another port, such as a patch panel port.

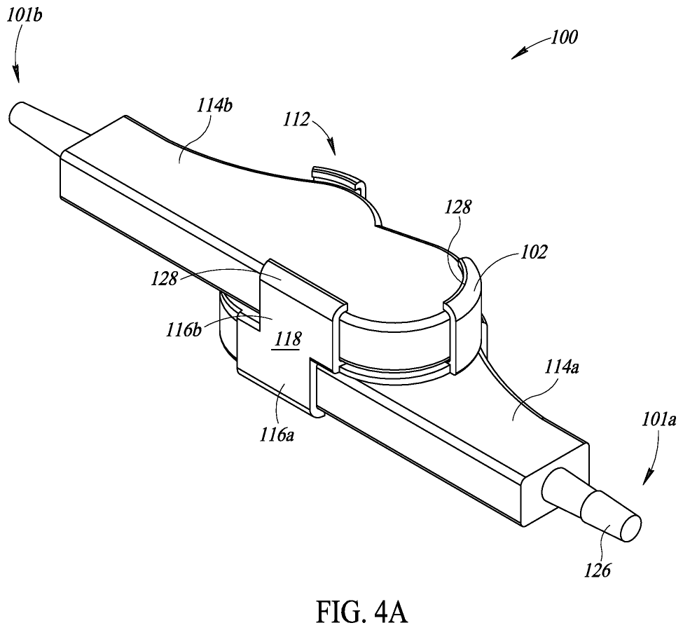

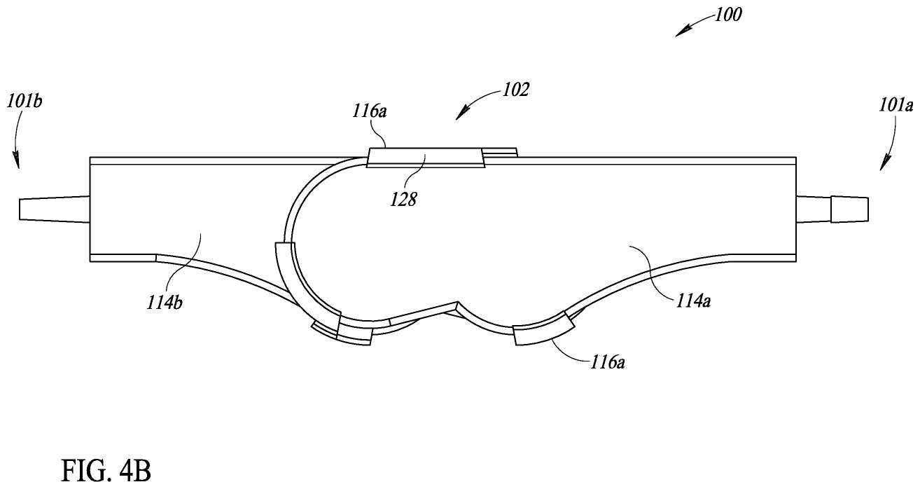

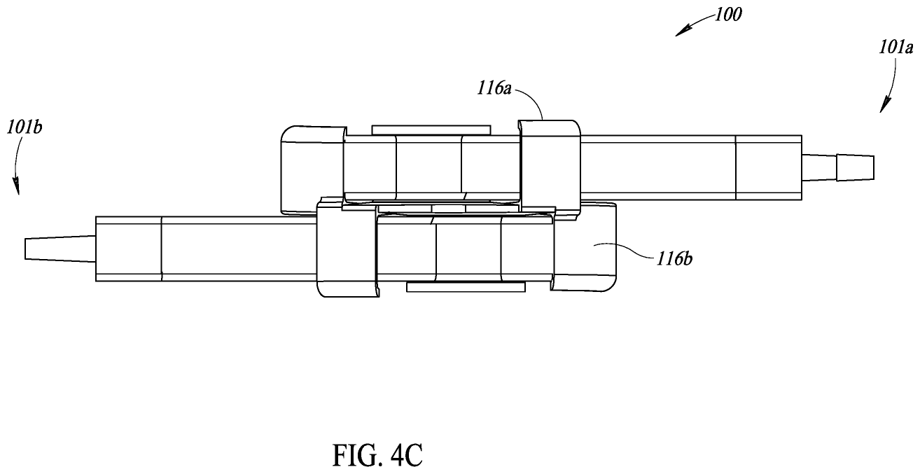

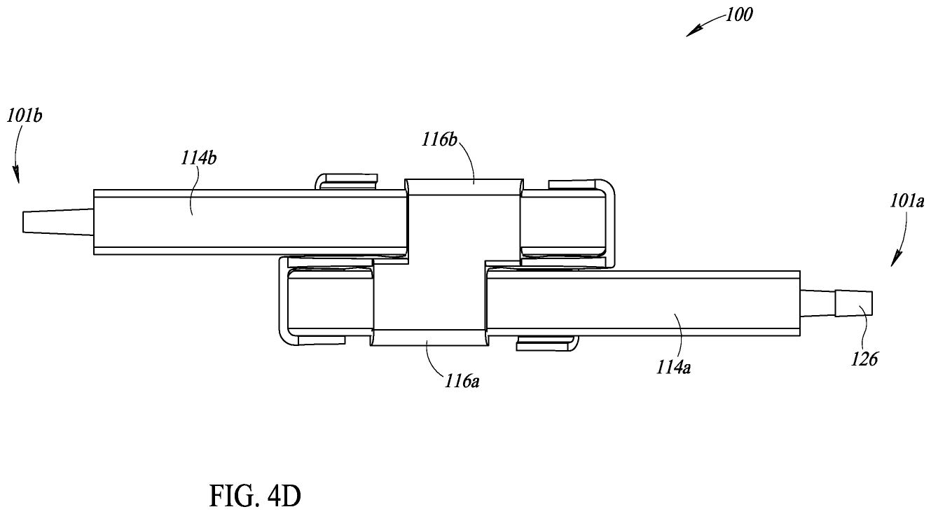

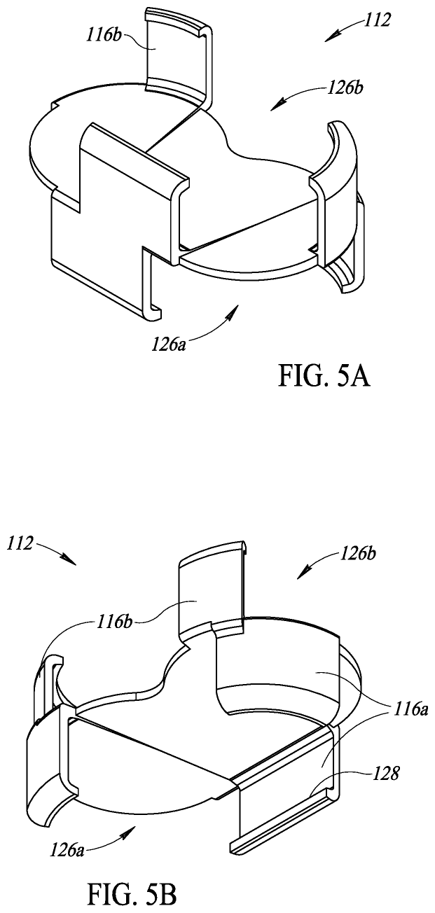

FIGS. 4A-4D show a dual end optical cleaning device 100 in accordance to another embodiment. In particular, FIG. 4A is a top isometric view of the dual end optical cleaning device 100; FIG. 4B is a top plan view of the dual end optical cleaning device 100; and FIG. 4C is a side view of the dual end optical cleaning device 100. FIGS. 5A-5D show the housing without the dual end optical cleaning device 100 of FIGS. 4A-4D installed therein.

In general, the dual end optical cleaning device 100 of FIGS. 4A-4C includes structure that performs similar function as is provided in the dual end optical cleaning device 10 of FIGS. 1A-1E, except that the cleaning tools are of a different shape, thereby affecting the shape of the housing and the components of the housing. Components of the housing of FIGS. 4A-4C and FIGS. 5A and 5B that perform the same function as the housing in the dual end optical cleaning device 100 will have the same reference numbers as the components of the dual optical cleaning device 10 but in the hundreds.

The dual end optical cleaning device 100 has a first end 101a and a second end 101b and includes a housing 112 that includes first and second portions 116a, 116b having first and second receiving sections 126a, 126b that receive and hold first and second optical cleaning tools 114a, 114b. The first and second optical cleaning tools 114a, 114b have a different configuration than the first and optical second cleaning tools 14a, 14b of FIGS. 1A-1E. Thus, the housing 112 has a different configuration as well. That is, the shape of the housing 112 corresponds to the shape of the optical cleaning tools 114a, 114b. The first and second receiving sections 126a, 126b of the first and second portions 116a, 116b of the housing 112 are curved so as to conform to the shape of the first and second optical cleaning tools 114a, 114b.

The housing 112 includes a plurality of latching members 128. The latching members 128 are located at a bottom surface of the first and second portions 116a, 116b and hold the first and second optical cleaning tools 114a, 114b therein. Each latching member 128 has a protrusion that engages around a lip or raised surface of the first and second optical cleaning tools 114a, 114b as best shown in FIGS. 4A and 4B.

Similar to the embodiment of FIGS. 1A-1E, the first optical cleaning tool 114a is held by the first portion 116a such that an end of the first optical cleaning tool 114a faces a first direction, while the second optical cleaning tool 114b is held by the second portion 116b such that an of the second optical cleaning tool 114b faces a second, opposite direction. Furthermore, similar to the embodiments previously mentioned, the first end of the first optical cleaning tool 114a is configured to clean optical fibers in a first configuration, such as a patch cord, while the second optical cleaning tool 114b has an end configured to clean optical fibers in a second configuration, such as a port. In the illustrated embodiment, the first and second optical cleaning tools 114a, 114b are the same;

however, the first end of the first optical cleaning tool 114a includes an adapter 125 that places the first optical cleaning tool 114a in the first configuration.

The housing 112 is made from a rigid material that allows some flexibility to remove and replace the optical cleaning tools 114a, 114b. To remove and replace an optical cleaning tool 114a, 114b in this embodiment, one or more of the latching members 128 may be flexed outwardly to disengage the protrusion of the respective latching member 128 from the raised surface of the optical cleaning tool to thereby allow the optical cleaning tool to be removed from the respective portion of the housing 112. To install an optical cleaning tool, the optical cleaning tool may be slid into the receiving member of the respective portion. The latching members 128 flex to cause the protrusions to extend over the raised surfaces of the optical cleaning tools and to engage therewith.

The various embodiments described above can be combined to provide further embodiments. For example, embodiments of the present disclosure are not limited to the size and shape of the housing, such as the first and second portions and the receiving sections. As mentioned above, the housing is designed to fit the configuration of the optical cleaning tool.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A dual end optical cleaning device, comprising:
a housing including a first receiving section laterally arranged relative to a second receiving section;
a first optical cleaning tool located in the first receiving section such that an end of the first optical cleaning tool is facing a first direction; and
a second optical cleaning tool located in the second receiving section such that an end of the second optical cleaning tool is facing a second direction, wherein the second direction is opposite the first direction.

2. The dual end optical cleaning device of claim 1, wherein the end of the first optical cleaning tool has a different configuration than the end of the second optical cleaning tool.

3. The dual end optical cleaning device of claim 2, wherein the end of the first optical cleaning tool is configured to clean an endface of an optical fiber held by a connector, wherein the end of the second optical cleaning tool is configured to clean an endface of an optical fiber held in a port.

4. The dual end optical cleaning device of claim 2, wherein the first and second optical cleaning tools are of a same type of optical cleaning tool, and wherein the first optical cleaning tool includes an adapter that makes the configuration of the end of the first optical cleaning tool different from the configuration of the end of the second optical cleaning tool.

5. The dual end optical cleaning device of claim 1, wherein the first receiving section includes a latching member configured to engage with the first optical cleaning tool, and the second receiving section includes a latching member configured to engage with the second optical cleaning tool.

6. The dual end optical cleaning device of claim 1, wherein the first and second receiving sections are integrally formed.

7. The dual end optical cleaning device of claim 1, wherein the housing is a rigid plastic material.

8. A dual end optical cleaning device, comprising:
a first portion holding a first optical cleaning tool so that an end of the first optical cleaning tool is facing in a first direction;
a second portion holding a second optical cleaning tool so that an end of the second optical cleaning tool is facing a second, different direction; and
a coupling region that couples the first portion to the second portion such that the first portion and the second portion are laterally arranged relative to each other.

9. The dual end optical cleaning device of claim 8, wherein the end of the first optical cleaning tool is configured to clean an endface of an optical fiber held by a connector, and wherein the end of the second optical cleaning tool is configured to clean an endface of an optical fiber held in a port.

10. The dual end optical cleaning device of claim 9, wherein the first and second optical cleaning tools are of a same type of optical cleaning tool, and wherein the first optical cleaning tool includes an adapter that makes the end of the first optical cleaning tool configured to clean an endface of an optical fiber held by a connector.

11. The dual end optical cleaning device of claim 8, wherein the second direction is opposite the first direction.

12. The dual end optical cleaning device of claim 8, wherein the first portion, the second portion, and the coupling region are a single integral piece.

13. The dual end optical cleaning device of claim 8, wherein first portion includes one or more latching members that hold the first optical cleaning tool therein, and wherein second portion includes one or more latching members that hold the second optical cleaning tool therein.

14. A method, comprising:
coupling a first end of a dual end optical cleaning device to an endface of an optical fiber that is held by a connector, the first end having a first cleaning element and extending in a first direction;
cleaning the endface of the optical fiber that is held by the connector using the first cleaning element;
rotating the dual end optical cleaning device;
coupling a second end of the dual end optical cleaning device to an endface of an optical fiber that is held in a port, the second end having a second cleaning element that is laterally arranged relative the first cleaning element and extending in a second, opposite direction; and
cleaning the endface of the optical fiber that is held in the port using the second cleaning element.

15. The method of claim 14, further comprising removing the first optical cleaning tool from the dual end optical cleaning device and replacing the first optical cleaning tool with a third optical cleaning tool.

16. The method of claim 15, wherein the third optical cleaning tool is of a same type of optical cleaning tool as the first optical cleaning tool.

17. The method of claim 14, wherein the port is a port of an electronic device or patch panel.

18. The method of claim 14, wherein rotating the dual end optical cleaning device comprises rotating the dual end optical cleaning device 180 degrees.

19. The method of claim 14, wherein the dual end optical cleaning device includes a housing that holds the first end in an opposite direction as the second end.

20. The method of claim 19, wherein the dual end optical cleaning device includes first and second optical cleaning tools installed in the housing so that first end of the first optical cleaning tool has the first cleaning element extending in the first direction and the second end of the second optical cleaning tool has the second cleaning element extending in the second direction.
